(19) United States
(12) Patent Application Publication
(10) Pub. No.: US 2026/0088491 A1
(43) Pub. Date: Mar. 26, 2026

(54) SELF-ORGANIZING DIRECTIONAL ANTENNA SYSTEM FOR RADIO STATIONS

(71) Applicant: Dimitris Kolokotronis, Athens (GR)

(72) Inventor: Dimitris Kolokotronis, Athens (GR)

(21) Appl. No.: 18/870,516

(22) PCT Filed: May 30, 2024
(86) PCT No.: PCT/EP2024/064960

§ 371 Date: Nov. 29, 2024

(30) Foreign Application Priority Data
May 30, 2023 (GB) 2308012.0

(51) Int. Cl. H01Q 3/04; H04B 7/06; H04W 36/08

(52) U.S. Cl. CPC H01Q 3/04; H04B 7/0617; H04W 36/085

(57) ABSTRACT

A self-organizing directional antenna system (100, 300, 500, 600) has an omnidirectional scanning antenna (102, 302, 502, 602) connected to a processor configured to establish communication with a wireless network having a plurality of radio base stations (RBSs), and to scan and select from the plurality of RBSs. A radio terminal station (RTS) directional antenna (114, 314a-c; 514a-c; 614a-c) is provided. A controller is configured to receive data identifying the selected RBS (96), determine the location of the selected RBS, use the location of the RTS antenna, and the position of the selected RBS, to control the RTS antenna system to connect the RTS antenna to the selected RBS.

### TECHNICAL FIELD

This invention relates to a smart antenna system for use on a radio terminal station serving itself or multiple radio terminal devices on a hotspot. Specifically, this invention relates to a directional antenna system that is self-configured/self-organized to locate, target and utilise the best serving radio base station within a geographical coverage area.

### BACKGROUND ART

Wireless telecommunication networks such as cellular radio networks typically comprise a plurality of radio base stations (RBS), each of which has a mast with multiple antennas (cells) mounted thereon. Each radio base station (RBS) serves a predetermined geographic area, and is configured to provide radio communication services to several radio terminal devices (RTDs).

A radio terminal station (RTS) is defined as the device that connects with at least one network radio base station (RBS) to transfer data therebetween by radio signal transmission. The RTS may offer signal re-transmission (wired or wireless) to offer service to at least one further radio terminal device (RTD). In this mode, the RTS can serve as an intermediate device. Alternatively, the RTS may be the endpoint itself (for example, the RTS may be a mobile device using the connection to browse the internet).

Examples of RTSs are mobile devices, smartphones, tablets, laptops, data cards, cellular chips, modem/routers, loT devices, signal repeaters and boosters, backhauling systems and the like. As mentioned, RTSs may be used as intermediate connecting members between the wireless telecommunication network RBSs and the RTDs that are herein considered to be the end-users of the network. An example of a smartphone used as an RTS is when a smartphone is set in wireless hotspot mode to offer WiFi® coverage to other smartphones, tablets, laptops and other RTDs in range. Another example is when a radio repeater/booster is used as an RTS in order to further re-transmit the initial RBS signals using a single antenna or a distributed antenna system to offer indoor coverage to RTDs in range. A further example is when a cellular chip is configured with a modem/router to utilize the initial RBS signals in order to operate as a backhauling system for a plurality of indoor radio units such as Ericsson's radio dots (TM) or similar to offer wireless network coverage to a hotspot.

By “hotspot” we mean a confined geographical area containing multiple terminal devices (RTDs) that are requesting service from a wireless telecommunication network. Hotspots can be static (indoor or outdoor) or moving in the wireless telecommunication network coverage footprint. Examples of static indoor hotspots are hotels, factories, and the like. Examples of static outdoor hotspots are stadiums, beaches, and the like. Examples of moving hotspots are passenger ships, passenger trains, and the like.

WO 94/26001 (WO'001) discloses a “pillbox” type LAN antenna having a low gain omnidirectional antenna coaxially mounted with several steerable directional antennas. The device is for use in wireless local area networks such as mobile field use, for example for mounting on the roof of a vehicle. It is for signals of the order of 60 GHz. A motor is responsive to signals indicative of the direction to which it is desired to rotate a reflector for reception of signals from a transmitter lying in that direction.

The omnidirectional antenna is used as a low gain signal acquisition antenna. When a received signal of interest is identified as lying at a particular direction from the antenna, the reflector assembly of one of the steerable antennas can be rotated to face in that direction in order to establish a higher gain communication link with the source of such received signal. In order to do this, WO'001 utilises progressive phase omni or PPO to determine the direction. Alternatively different azimuth portions of the omnidirectional antenna are utilised alternately. This solution performs radio measurements to identify the direction of the best serving radio Base Station.

US 2010/0150038 (US'038) discloses an apparatus and method for wireless communication in a WLAN or mesh network. It discusses the drawbacks of omnidirectional antennas. The system of US'038 has multiple stations each having multiple antennas. US'038 states that received signal quality is determined based on signals received by the omni-directional antenna, and as a result may select a directional antenna. The directional antenna is selected if the location of the target station is known-and this may be determined by switching between antennas and determining the highest signal strength. This solution performs radio measurements to identify the direction of the best serving radio Base Station.

The applicant's prior application WO 2016/087431 discloses a mobile vehicle system in which scanning antenna(s) and donor antenna(s) are provided. The scanning antenna(s) determine the best heading for radio reception, and the donor antenna(s) is either selected based on the best direction, or steered to that position. In one embodiment, there is a single steered scanning antenna and a single steered donor antenna. In another embodiment, there are a plurality of each, and instead of steering, RF switching between the antennas is utilised for both scanning and donor operation.

Either way, the antennas need to have a relatively wide radiation pattern in the horizontal plane (H-plane).

Conversely, the use of antennas with narrow radiation patterns on the H-plane offer high gain towards the best serving radio base station and good interference rejection performance (due to received signal attenuation of the neighbouring radio base stations). To achieve optimum performance, directional antennas of very narrow −3 dB h-plane beamwidth should be used. However, using multiple antennas (RF switching) or separate scanning and donor antennas (azimuth steering) of very narrow −3 dB h-plane beamwidth either requires a high number of antennas fixed in the azimuth direction or long horizontal scanning cycles (360°) to detect and locate the best serving radio base station direction. Both prior art techniques are undesirable either due to the high implementation costs involved or due to the complexity of implementation.

This is particularly true for 360° scanning, since this is done, either using multiple fixed direction antennas (discrete radio condition evaluation in each of the plurality of directions) or azimuth steering antennas (discrete radio condition evaluation in each of the plurality of directions). Such scanning evaluation mechanisms do not take into account all candidate best serving radio base stations in a single evaluation (i.e., all together). The prior art solutions instead perform radio measurements to identify the direction of the best serving radio Base Station.

The problem with the prior art is that best serving radio base station is selected using measurements of the radio conditions according to proprietary methods and algorithms. By radio conditions we mean the received signal strength, the signal to noise and interference ratio (SNIR) and the like. In the prior art, the mobile station (UE)/radio base station connection/registration process, known as “cell search and selection procedure”, is not taken into account when Radio Base station searching and selection is performed in order to identify the direction of the best serving radio Base Station. By “best serving” we mean the RBS with the highest performance of all of the RBSs in serving range.

By “cell search and selection procedure” we mean a radio terminal station or device (i.e. a UE) goes through a specific decision making process to pick up a specific radio base station (cell) out of a plurality to connect/register on the wireless telecommunication network. In 4G (LTE) and 5G (NR) technology networks the 3GPP TS 36.304 and 3GPP TS 38.304 respectively provide the detailed technical specifications on how cell search and selection should be performed on this technology networks, ensuring that 4G and 5G devices can effectively connect to the best available 4G and 5G radio base station. It is envisaged that as future technologies are developed beyond 4G and 5G, the present invention will utilise the relevant cell search and selection process according to the newly developed standards.

Using proprietary radio measurements to identify the direction of the best serving RBS is highly inaccurate, complex and expensive. Proprietary radio measurements miss RBS important performance information on the selection process such as operational bands and bandwidths, Carrier Aggregation (CA) capabilities, MIMO order (SISO, 2×2, 4×4 or massive-MIMO) and traffic loads to mention a few. Particularly important, especially for vehicles, is also the handover decisions and mobility management of the RTS system. In the prior art, the identification of a new direction for the next selected best serving RBS (i.e. handover) is also performed using proprietary radio measurements. The standardized, vendor and operator cell re-selection procedures are totally ignored as the system moves between different RBS dominant areas clearly impacting its mobility performance.

### SUMMARY OF INVENTION

According to a first aspect of the present invention there is provided a self-organizing directional antenna system for connection to a radio terminal station (RTS), the system comprising:
an omnidirectional scanning antenna connected to a processor, the processor being configured to:
   establish communication with a wireless network comprising a plurality of radio base stations (RBSs); and,
   scan and select an RBS from the plurality of RBSs;
an RTS antenna system comprising at least one directional RTS antenna;
a controller configured to:
   receive data identifying the selected RBS from the processor;
   determine the location of the selected RBS by referring to a database containing RBS location data;
using the location of the RTS antenna system, and the location of the selected RBS, control the RTS antenna system to align the RTS antenna towards the direction of the selected RBS.

Advantageously the present invention uses a broad beam antenna (such as an omnidirectional antenna) to identify all available serving RBSs, select the best serving RBS out of the plurality and then control the system's directional antennas as such to target towards the direction of the best serving RBS.

The scanning antenna may be connected to user equipment (UE) or a cellular chip with a SIM card or eSIM, being configured to undertake a cell search, selection and reselection procedure according to network standards, vendor and operator proprietary algorithms. Advantageously, the present invention uses the network's standard procedure to select the most appropriate RBS to connect to.

Preferably the cell search, selection and reselection procedure is according to the wireless network standards (i.e. for 4G and 5G technology wireless networks according to the relevant 3GPP standards).

In one embodiment, the RTS antenna system comprises means for selecting a beam direction of the RTS antenna system, and wherein the controller is configured to control the means for selecting a beam direction.

For example, the at least one RTS antenna is a steerable antenna, and the means comprises a steering actuator to steer the RTS antenna. In this case, the step of controlling the means for selecting a direction of the RTS antenna system may comprise the step of directing the centre of the beam of the steerable antenna in the direction of the RBS.

Alternatively, the RTS antenna system comprises a plurality of RTS antennas positioned with respective beams in different directions. The means for selecting a direction of the RTS antenna system may in this case comprise a switch for switching between each of the plurality of RTS antennas connected to the RTS.

Preferably there is provided a locator for determining the position of the RTS antenna. In some embodiments-e.g. moving vehicles, the position of the RTS antenna is updated periodically, and wherein the controller is provided with an updated position of the RTS antenna. There may be provided a DGPS/GNSS system for determining the direction of the system.

In a further embodiment:
the RTS antenna system comprises a plurality of RTS antennas positioned with respective beams in different directions; and,
each of the plurality of RTS antennas is configured to serve a different RTS.

Each RTS antenna may be assigned a different RBS by the controller.

A first RTS antenna may be assigned the best serving RBS and the second RTS antenna is assigned the first neighbour RBS as identified by the cell search and selection procedure.

Each subsequent RTS antenna may be assigned a subsequent neighbour RBS according to an order of preference from the cell search and selection procedure.

In a further embodiment:
the RTS antenna system comprises a plurality of RTS antennas positioned with respective beams in different directions;
the directional antenna system comprises a bonding unit; and,
each of the plurality of RTS antennas is connected to the bonding unit to thereby serve a single RTS.

The controller may be connected to a database of RBS locations, and is configured to obtain the location of the RBS based on information provided from the UE or cellular chip comprising the SIM or eSIM connected to the scanning antenna.

The controller may comprise a veto list wherein selected RBSs are vetoed.

At least two scanning antennas connected to different networks may be provided.

Preferably the scanning antenna is an omnidirectional antenna.

According to a second aspect there is provided a method of operating a self-organizing directional antenna system comprising the steps of:
providing at least one radio base station (RBS);
providing an omnidirectional scanning antenna;
providing a processor connected to the omnidirectional scanning antenna;
providing an RTS antenna system comprising at least one directional RTS antenna;
using the processor to establish communication between the scanning antenna and a wireless network comprising a plurality of radio base stations (RBSs);
using the processor to scan and select the best serving RBS from the plurality of RBSs;
receiving data from the processor identifying the selected best serving RBS;
determining the location of the best serving RBS by referring to a database containing RBS location data;
   using the location of the RTS antenna system, and the location of the selected best serving RBS to determine a target heading; and,
   controlling the RTS antenna system to align the RTS antenna to the direction of the selected best serving RBS according to the target heading.

### BRIEF DESCRIPTION OF DRAWINGS

An embodiment of the present invention will now be described with reference to the following figure in which:

FIG. 1 is a schematic of a first system, according to the present invention;

FIG. 2 is a flow diagram of a method of operation of the system of FIG. 1;

FIG. 3a is a perspective view of an antenna for use with the system of FIG. 1;

FIG. 3b is a side view of the antenna of FIG. 3a;

FIG. 3c is a side view of the antenna of FIG. 3a;

FIG. 4 is a schematic of a second system, according to the present invention;

FIG. 5 is a flow diagram of a method of operation of the system of FIG. 4;

FIG. 6 is a schematic of a third system, according to the present invention; and,

FIG. 7 is a schematic of a fourth system, according to the present invention.

### DESCRIPTION OF THE FIRST EMBODIMENT

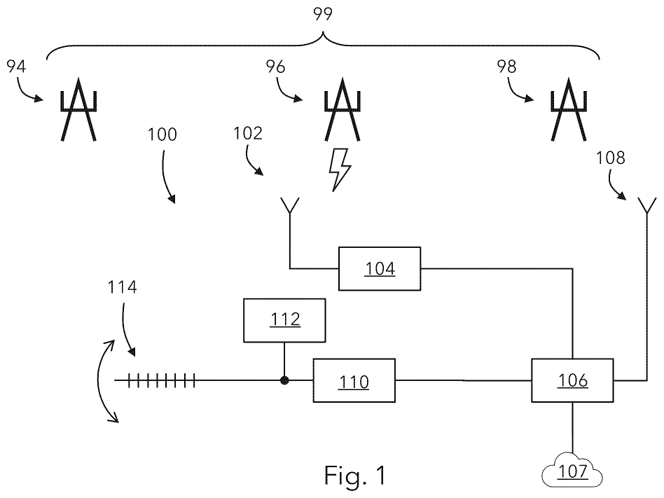

Referring to FIG. 1, a first self-organizing directional antenna system 100 according to the present invention is shown.

### Configuration

The system comprises a scanning antenna 102, a cellular chip 104, a controller 106, a GPS antenna 108, a steering actuator 110, an RTS 112 and an RTS antenna 114. Three radio base stations RBS 94, 96, 98 are shown, in different positions relative to the system 100 and making up a radio network 99.

The scanning antenna 102 is omnidirectional. The omnidirectional scanning antenna 102 is connected to a separate terminal device (i.e., a cellular chip 104). The cellular chip 104 comprises a SIM card and will connect to the radio network using the omnidirectional antenna.

The controller 106 is configured to receive data from the cellular chip 104, data from the GPS antenna 108 and to transmit data to the actuator 110.

The controller 106 is configured to access a database 107. The database 107 is shown to be remote (cloud based) but may be local to the controller 106. The database holds the coordinates of a plurality of RBS cell identification codes for the serving radio network 99.

The controller 106 is connected to the GPS antenna 108 (or similar positioning device) that provides the controller with real-time coordinates for the location of the RTS antenna 114.

The RTS 112 is connected to the RTS antenna 114.

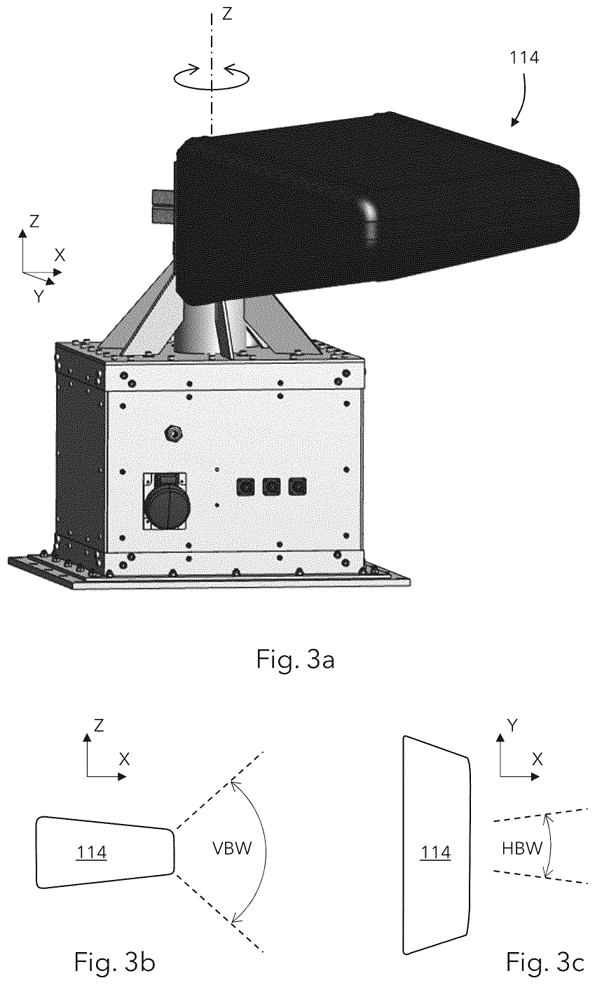

The RTS antenna 114 is a directional antenna of narrow −3 dB beamwidth serving the terminal device RTD 112. Antennas could be S-Pol, X-pol, MIMO, massive-MIMO, active, multiband and the like. An example antenna 114 is shown in FIGS. 3a to 3c, having a narrow horizontal beamwidth HBW, but a broad vertical beamwidth VBW.

### Use

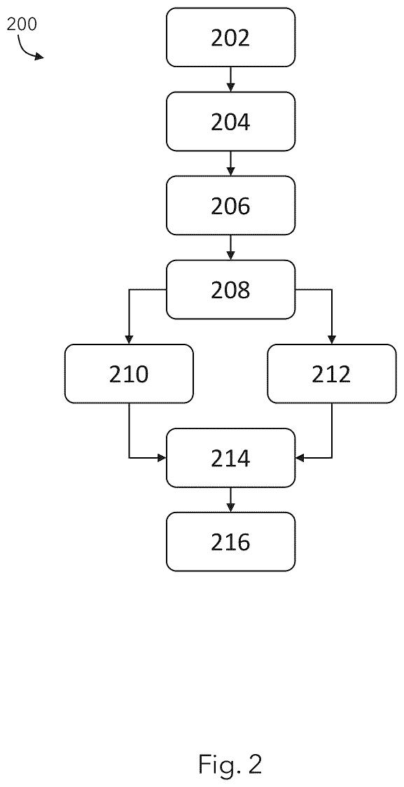

Referring to FIG. 2, a method of operation 200 of the system 100 is shown.

At step 202, the system 100 is initialised. At step 204, the chip 104 is activated and attempts to connect to/register with the network (through a cell search and selection procedure).

The known cell search and selection process operates broadly as follows:
Cell search—the chip 104 scans the environment for nearby RBSs 94, 96, 98. When RBSs are detected, the chip will receive data identifying that RBS;
Evaluation—the chip 104 evaluates each of the detected RBSs based on predetermined criteria. The criteria are properties of the signal-with a view to obtaining the strongest and clearest signal;
Selection—the chip then selects the RBS with the ‘best’ evaluated properties.

In this known method, the result is that the chip (typically connected to an omnidirectional antenna) connects to the best RBS. It does not know, or need to know, where that RBS is (only that it is in serving range).

After detecting one or more candidate radio base station signals from the plurality (94, 96, 98), the chip will connect to/register with to the best available serving radio base station 96, as is known in the art and described above.

The cellular chip 104 then identifies the serving cell identification code at step 206 (the cellular chip is attributed to an identifier that is unique to the serving cell). The serving cell identification code is sent to the controller 106 at step 208.

At step 210 the controller 106 determines the position of the antenna 114 using the GPS antenna 108. At step 212 the controller 106 determines the position of the “best” RBS (i.e., the one assigned to the antenna 102 for registration) based on the serving cell identification code, and a lookup operation in the database 107.

At step 214, the controller 106 calculates a virtual line-of-site between the two points. The first point is the location of the terminal device (coordinates given to the controller from the GPS circuitry 108) and the second point is the location of the best serving radio base station selected by the radio network registration process (coordinates have been recovered from the local (or remote) database 107 after matching the best serving radio base station cell identification codes with its stored coordinates).

Once this information has been determined, at step 216 the controller 106 instructs the steering device 110 to steer the antenna 114 to the direction of the radio base station 96. The directional antenna 114 is now directed to the appropriate, “best” radio base station 96, experiencing far better received signal strength and a much-improved signal to interference and noise ratio (SNIR) compared to the omnidirectional antenna 102.

The present invention utilises the known process of cell search and selection, and combines it with location data (which may be publicly available and/or published by the networks) to determine the heading for the directional antenna.

### Variation to the First Embodiment

When the system 100 is installed on a vehicle, the process of step 214 repeats in real-time, re-calculating the virtual line-of-site between the antenna 114 and RBS, instructing the steering device 110 to steer the antenna 114 to the direction of the RBS 96. This process is repeated until a new “best” radio base station 96 is identified by the RTS scanning antenna, either enforcing a repeated re-registration process or through a handover or the appropriate cell re-selection procedure.

In a further embodiment, a GNSS receiver may be used to determine the location and/or orientation of the system 100. Evidently if the position of the system 100 is moveable (for example if it is installed on a vehicle) then its position and heading is required to determine the heading which the local antenna needs to be directed to. Heading can usually be determined by a change in position (giving a direction of travel). The present invention envisages the use of differential GPS (DGPS) for improved accuracy. It will be noted that in some circumstances, the system may rotate without moving position (e.g. an anchored ship) and as such understanding orientation absent linear movement is essential.

### Description of the Second Embodiment

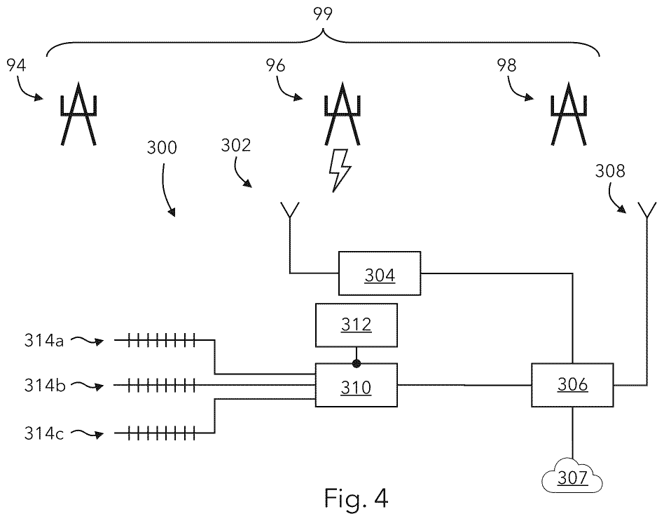

Referring to FIG. 4, a second self-organizing directional antenna system 100 according to the present invention is shown.

### Configuration

The system comprises a scanning antenna 302, a cellular chip 304, a controller 306, a GPS antenna 308, an RF switch 310, an RTS 312 and a plurality of RTS antennas 314a, b, c etc.

The scanning antenna 302 is omnidirectional. The omnidirectional scanning antenna 302 is connected to a separate terminal device (i.e., a cellular chip 304). The cellular chip 304 comprises a SIM card and will connect to/register with the radio network using the omnidirectional antenna.

The controller 306 is configured to receive data from the cellular chip 304, data from the GPS antenna 308 and to transmit data to the RF switch 310.

The controller 306 is configured to access a database 307. The database 307 is shown to be remote (cloud based) but may be local to the controller 306. The database holds the coordinates of a plurality of RBS cell identification codes for the serving radio network 99.

The controller 306 is connected to the GPS antenna 308 (or similar positioning device) that provides the controller with real-time coordinates for the location of the RTS antenna 314.

The RTS 312 is connected to the RTS antennas 312a, b, c etc.

Each of the RTS antennas 314a, b, c etc. is a directional antenna of narrow −3 dB beamwidth serving the terminal device RTD 312. Antennas could be S-Pol, X-pol, MIMO, massive-MIMO, active, multiband and the like.

### Use

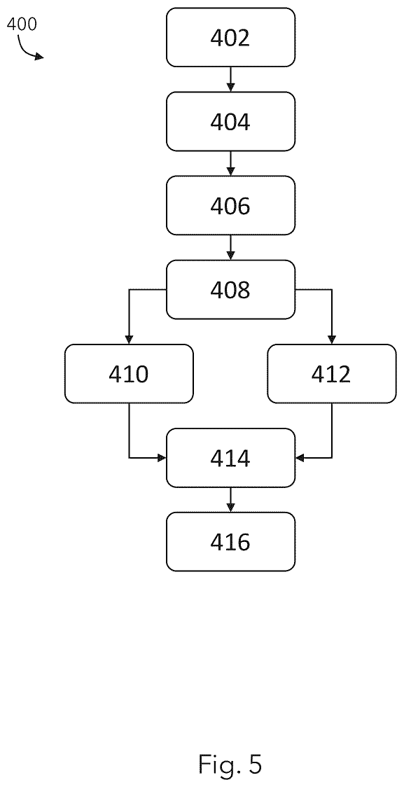

Referring to FIG. 5, a method of operation 400 of the system 300 is shown.

At step 402, the system 300 is initialised. At step 404, the chip 304 is activated and attempts to connect to the network (through a cell search and selection procedure). After detecting candidate radio base station signals from the plurality, the chip will connect to/register with to the best available serving radio base station 96, as is known in the art.

The cellular chip 304 then identifies the serving cell identification code at step 406. The serving cell identification code is sent to the controller 306 at step 408.

At step 410 the controller 306 determines the position of the antenna 314 using the GPS antenna 308. At step 412 the controller 306 determines the position of the “best” RBS (i.e., the one assigned to the antenna 302) based on the serving cell identification code, and a lookup operation in the database 307.

At step 414, the controller 306 calculates a virtual line-of-site between the two points. The first point is the location of the terminal device (coordinates given to the controller from the GPS circuitry 308) and the second point is the location of the best serving radio base station selected by the radio network cell search and selection procedure (coordinates have been recovered from the local (or remote) database 307 after matching the best serving radio base station cell identification codes with its stored coordinates).

Once this information has been determined, at step 416 the controller 306 instructs the RF switch 310 to select the antenna 314a, b, c etc closest to the direction of the base station 96. The directional antenna 314a, b, c etc is now directed to the appropriate, “best” radio base station 96, experiencing far better received signal strength and a much-improved signal to interference and noise ratio compared to the omnidirectional antenna 302.

### Variation to the Second Embodiment

When the system 100 is installed on a vehicle, the process of step 414 repeats in real-time re-calculating the virtual line-of-site between the antenna 114 and RBS, instructing the RF switch 310 to select the antenna 314a, b, c etc closest to the direction of the RBS 96. This process is repeated until a new “best” radio base station 96 is identified by the RTS scanning antenna, either enforcing a repeated re-registration process or through a handover or any appropriate cell re-selection procedure.

In a further embodiment, a GNSS receiver may be used to determine the location and/or orientation of the system 100. Evidently if the position of the system 100 is moveable (for example if it is installed on a vehicle) then its position and heading is required to determine the heading which the local antenna needs to be directed to. Heading can usually be determined by a change in position (giving a direction of travel). The present invention envisages the use of differential GPS (DGPS) for improved accuracy. It will be noted that in some circumstances, the system may rotate without moving position (e.g. an anchored ship) and as such understanding orientation absent linear movement is essential.

### Description of the Third Embodiment

The above described system may be combined with the applicant's co-pending application GB2210526.6.

In that co-pending application, a plurality of directional antennas in different directions are used to serve specific areas e.g., of a ship.

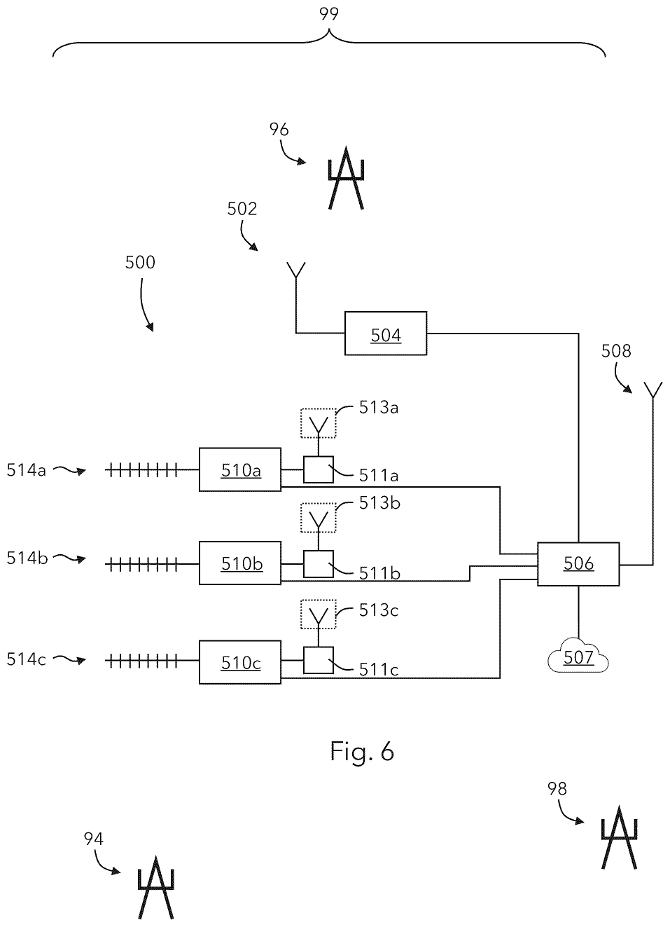

Referring to FIG. 6 a system 500 is shown according to the present invention. The system 500 comprises a scanning antenna 502, a cellular chip 504, a controller 506, a GPS antenna 508, actuators 510a, 510b, 510c, a plurality of directional, steerable antennas 514a, b, c, each antenna connected to a different RTS 511a, 511b, 511c (i.e. as with GB2210526.6 the RTS being a radio signal repeater or booster), where each RTS serving a respective area 513a, 513b, 513c.

As with GB2210526.6, each area 513a, b, c covers a different but adjacent (or overlapping) area.

The scanning antenna 502 is omnidirectional. The omnidirectional scanning antenna 502 is connected to a separate terminal device (i.e., a cellular chip 504). The cellular chip 504 comprises a SIM card and will connect to/register with to the radio network using the omnidirectional antenna.

The controller 506 is configured to receive data from the cellular chip 504, data from the GPS antenna 508 and to transmit data to the antenna actuators 510a, b, c.

The controller 506 is configured to access a database 507. The database 507 is shown to be remote (cloud based) but may be local to the controller 506. The database holds the coordinates of a plurality of RBS cell identification codes for the serving radio network 99.

The controller 506 is connected to the GPS antenna 508 (or similar positioning device) that provides the controller with real-time coordinates for the location of the system.

The controller 506 determines the N best RBSs 94, 96, 98 and assigns each antenna 514a, b, c to a respective RBS. Each antenna is then steered to that RBS. Therefore each area 513a, b, c is served by a different RBS 94, 96, 98 via the directional antennas.

It will be noted that each antenna 514a, b, c may be rotatable through 360 degrees, or alternatively they may have a more limited range of movement (but collectively covering 360 degrees). In the latter case, the controller 506 will select the appropriate RBS based on heading.

Each of the antennas 514a, b, c etc. is a directional antenna of narrow −3 dB beamwidth serving each respective RTS 511a, 511b, 511c. Antennas could be S-Pol, X-pol, MIMO, massive-MIMO, active, multiband and the like.

### Description of the Fourth Embodiment

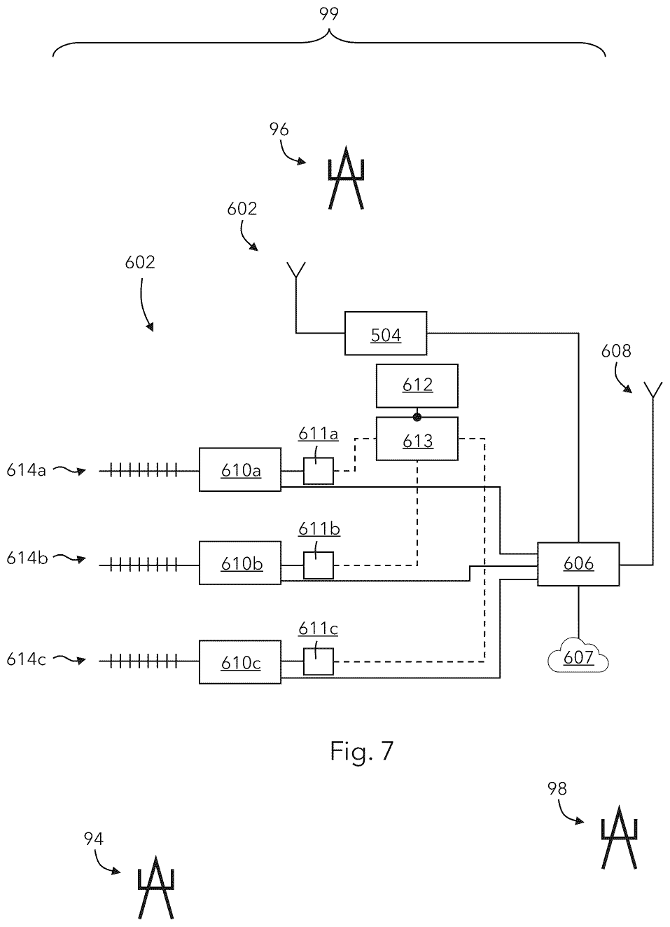

Referring to FIG. 7 a system 600 is shown according to the present invention. The system 600 comprises a scanning antenna 602, a cellular chip 604, a controller 606, a GPS antenna 608, actuators 610a, 610b, 610c, a plurality of directional, steerable antennas 614a, b, c, the antennas connected to different RTSs (a, b, c, etc) and all RTSs are connected to a bonding (or bundling) unit 613 which in turn serves or offers service to one or more access point or a hotspot 612 serving one or more RTDs via e.g. a wired (ethernet) or wireless (Wi-Fi™) connection.

An RTS in such a scenario could be a modem/router that is connected to an LTE or 5G SA network and outputs a IP data connection through an ethernet port. Multiple data connections (through multiple RTSs) connect to a bonding or bundling device. Bonding (or bundling) is the process of aggregating multiple individual connections into a single connection. By bonding one may combine the resources of multiple radio base stations of the same wireless network (or multiple radio base stations of different wireless networks) in order to increase the capacity of a “single” connection.

The scanning antenna 602 is omnidirectional. The omnidirectional scanning antenna 602 is connected to a separate terminal device (i.e., a cellular chip 604). The cellular chip 604 comprises a SIM card and will connect to the radio network using the omnidirectional antenna.

Multiple scanning antennas could be used. A scanning antenna for network A and a different scanning antenna for network B. Both scanning antennas would provide input to the controller 606, such that the system can take advantage of connections across multiple networks.

The controller 606 is configured to receive data from the cellular chip 604, data from the GPS antenna 608 and to transmit data to the antenna actuators 610a, b, c.

The controller 606 is configured to access a database 607. The database 607 is shown to be remote (cloud based) but may be local to the controller 606. The database holds the coordinates of a plurality of RBS cell identification codes for the serving radio network 99.

The controller 606 is connected to the GPS antenna 608 (or similar positioning device) that provides the controller with real-time coordinates for the location of the system.

The controller 606 determines the N best RBSs 94, 96, 98 and assigns each antenna 614a, b, c to a respective RBS. Each antenna is then steered to that RBS.

It will be noted that each antenna 614a, b, c may be rotatable through 360 degrees, or alternatively they may have a more limited range of movement (but collectively covering 360 degrees). In the latter case, the controller 606 will select the appropriate RBS based on heading.

The data to and from each antenna 610a, 610b, 610c is bound in the binding unit 611 so as to feed the RTS 612. The signals are combined so as to provide a higher data bandwidth.

Each of the antennas 614a, b, c etc. is a directional antenna of narrow −3 dB beamwidth serving each respective rebroadcast antenna 513a, b, c. Antennas could be S-Pol, X-pol, MIMO, massive-MIMO, active, multiband and the like.

### Variations

The above embodiment employs a cellular chip, although this could be any means or device capable of performing a cell search and selection procedure. The means may be capable of reporting the neighbouring radio base stations detected at any given point (i.e., it may report the cell identification codes of all radio base stations offering coverage at that location).

The SIM card may be an eSIM and may be network specific or global.

The means may be set with priorities on cell search and selection procedure. Priorities may include cell search and selection procedure on Mobile Country Code (MCC), Mobile Network Code (MNC) and the like. Other priorities may include frequencies of operation, MIMO capability and the like. The cellular chip or device may be instructed or programmed to perform the cell search and selection according to predefined priorities.

The controller may exclude specific selected radio base stations at discrete locations. An exemplary scenario that a selected “best” radio base stations at discrete location may be excluded is when the selected “best” radio base station is a high traffic (traffic loaded) radio base station. In such a scenario, the controller (according to “VETO” criteria) may decide to direct the directional antenna to a neighbouring radio base station direction detected at point out of the plurality.

Vendors may develop proprietary algorithms for faster and more efficient cell search and selection within the standardized framework. These algorithms can optimize signal processing and decision-making processes. For example vendors might implement optimizations to speed up the scanning process, but the basic method of detecting and synchronizing with cells is standardized. In another example, the UE selects a cell based on standardized criteria (S-Rxlev and S-Qual). Vendors can enhance how these measurements are performed or how the UE handles borderline cases, but the selection criteria themselves are defined by 3GPP. In another example, while the criteria for cell reselection are standardized, vendors might implement proprietary methods to predict and respond to changes in signal conditions more quickly or accurately, providing a smoother user experience.

Vendors might offer additional features or settings that go beyond the basic requirements of the standards, such as advanced load balancing techniques, more granular control over cell reselection parameters, or enhanced radio base station antenna management in 5G.

Performance Optimization: Vendors often optimize their hardware and software implementations to maximize performance, reduce power consumption, and improve the speed and reliability of the cell search and selection process.

1. A self-organizing directional antenna system for connection to a radio terminal station (RTS), the system comprising:
an omnidirectional scanning antenna connected to a processor, the processor being configured to:
establish communication with a wireless network comprising a plurality of radio base stations (RBSs); and,
scan and select an RBS from the plurality of RBSs;
an RTS antenna system comprising at least one directional RTS antenna;
a controller configured to:
receive data identifying the selected RBS from the processor;
determine the location of the selected RBS by referring to a database containing RBS location data;
using the location of the RTS antenna system, and the location of the selected RBS, control the RTS antenna system to align the RTS antenna towards the direction of the selected RBS.

2. A self-organizing directional antenna system according to claim 1, wherein the processor is a cellular chip comprising a SIM card or eSIM configured to carry out a cell search and selection procedure according to network standards, vendor and operator proprietary algorithms in order to identify the best serving RBS.

3. A self-organizing directional antenna system according to claim 2, wherein the cellular chip is configured to carry out a cell reselection procedure.

4. A self-organizing directional antenna system according to claim 2 or 3, wherein the cell search, selection and reselection procedure is according to the relevant 3GPP standards.

5. A self-organizing directional antenna system according to any preceding claim, wherein the RTS antenna system comprises means for selecting a beam direction of the RTS antenna system, and wherein the controller is configured to control the means for selecting a beam direction.

6. A self-organizing directional antenna system according to claim 5, wherein the at least one RTS antenna is a steerable antenna, and the means comprises a steering actuator to steer the RTS antenna.

7. A self-organizing directional antenna system according to claim 6, wherein the step of controlling the means for selecting a direction of the RTS antenna system comprises the step of directing the centre of the beam of the steerable antenna in the direction of the RBS.

8. A self-organizing directional antenna system according to claim 5, wherein the RTS antenna system comprises a plurality of RTS antennas positioned with respective beams in different directions.

9. A self-organizing directional antenna system according to claim 8, wherein the means for selecting a direction of the RTS antenna system comprises a switch for switching between each of the plurality of RTS antennas connected to the RTS.

10. A self-organizing directional antenna system according to any preceding claim, comprising a locator for determining the position of the RTS antenna.

11. A self-organizing directional antenna system according to claim 10, comprising a DGPS system for determining the direction of the system.

12. A self-organizing directional antenna system according to claim 10 or 11, wherein the position of the RTS antenna is updated periodically, and wherein the controller is provided with an updated position of the RTS antenna.

13. A self-organizing directional antenna system according to any preceding claim, wherein:
the RTS antenna system comprises a plurality of RTS antennas positioned with respective beams in different directions; and,
each of the plurality of RTS antennas is configured to serve a different RTS.

14. A self-organizing directional antenna system according to claim 13, wherein each RTS antenna is assigned a different RBS by the controller.

15. A self-organizing directional antenna system according to claim 14, wherein a first RTS antenna is assigned the best serving RBS and the second RTS antenna is assigned the first neighbour RBS as identified by the cell search and selection procedure.

16. A self-organizing directional antenna system according to claim 15, wherein each subsequent RTS antenna is assigned a subsequent neighbour RBS according to an order of preference from the cell search and selection procedure.

17. A self-organizing directional antenna system according to any preceding claim, wherein:
the RTS antenna system comprises a plurality of RTS antennas positioned with respective beams in different directions;
the directional antenna system comprises a bonding unit; and,
each of the plurality of RTS antennas is connected to the bonding unit to thereby serve a single RTS.

18. A self-organizing directional antenna system according to any preceding claim, wherein the controller comprises a veto list wherein selected RBSs are vetoed.

19. A self-organizing directional antenna system according to any preceding claim, comprising at least two scanning antennas connected to different networks.

20. A method of operating a self-organizing directional antenna system comprising the steps of:
providing at least one radio base station (RBS);
providing an omnidirectional scanning antenna;
providing a processor connected to the omnidirectional scanning antenna;
providing an RTS antenna system comprising at least one directional RTS antenna;
using the processor to establish communication between the scanning antenna and a wireless network comprising a plurality of radio base stations (RBSs);
using the processor to scan and select the best serving RBS from the plurality of RBSs;
receiving data from the processor identifying the selected best serving RBS;
determining the location of the best serving RBS by referring to a database containing RBS location data;
using the location of the RTS antenna system, and the location of the selected best serving RBS to determine a target heading; and,
controlling the RTS antenna system to align the RTS antenna to the direction of the selected best serving RBS according to the target heading.
